(19) United States
(12) Patent Application Publication
(10) Pub. No.: US 2009/0169091 A1
(43) Pub. Date: Jul. 2, 2009

(54) Method for performing a quality control on the processing of products and device applied thereby

(76) Inventor: José André Corneluis Coopman, Ieper (BE)

Correspondence Address: BACON & THOMAS, PLLC, 625 SLATERS LANE, FOURTH FLOOR, ALEXANDRIA, VA, 22314-1176, US

(21) Appl. No.: 11/920,644

(22) PCT Filed: May 18, 2006
(86) PCT No.: PCT/BE2006/000053

§ 371 Date: Apr. 7, 2008

(30) Foreign Application Priority Data
May 19, 2005 (BE) 2005/0248

(51) Int. Cl. G06K 9/00; G08B 21/00

(52) U.S. Cl. 382/141; 340/540

(57) ABSTRACT

Method for performing a quality control of a processed product, characterised in that it mainly consists in first storing images of a product (3) in a memory (11) during and/or after its desired and correct processing; in recording images of a product (3) to be checked during and/or after its processing; in comparing the recorded images to the images in the memory (11); and in taking action if the recorded images differ from the images in the memory, either to reject the product (3) or to reposition or adjust the product (3).

The present invention concerns a method for performing a quality control on the processing of products, in particular the folding of steel plates or the like.

It is known to implement several checkpoints in a production process to check the quality of the processed products.

The present invention concerns a method for checking the quality, whereby every product to be processed can be checked right before, during and immediately after a performed working step.

To this end, a method according to the invention mainly consists in first storing images of a product in a memory during and/or after its correct processing; in recording images of a product to be checked during and/or after its processing; in comparing the recorded images to the images in the memory; and in taking action if the recorded images differ from the images in the memory, either to reject the product or to reposition or adjust the product.

An advantage of the present invention is that the quality of the product can be checked during or immediately after its processing, such that in case of a possible production failure, not the entire batch will have to be checked for any possible defects, as the defect will be restricted to a single product.

Another advantage of the present invention is that any possible faults occurring during the production can be set right immediately, such that the processed product can still meet all possible quality requirements. Thus, when detecting a fault, for example a steel plate being insufficiently bent, the processing step concerned, i.e. the folding, can be repeated so as to adjust the formed fold.

The present invention also concerns a device which can be applied with a method according to the invention, which device consists of at least one or several image sensors; one or several image processors comprising a memory and a processor; and a control unit.

In order to better explain the characteristics of the present invention, the following preferred embodiment of a method according to the invention is given as an example only without being limitative in any way, as well as some preferred devices used thereby, with reference to the accompanying drawings, in which:

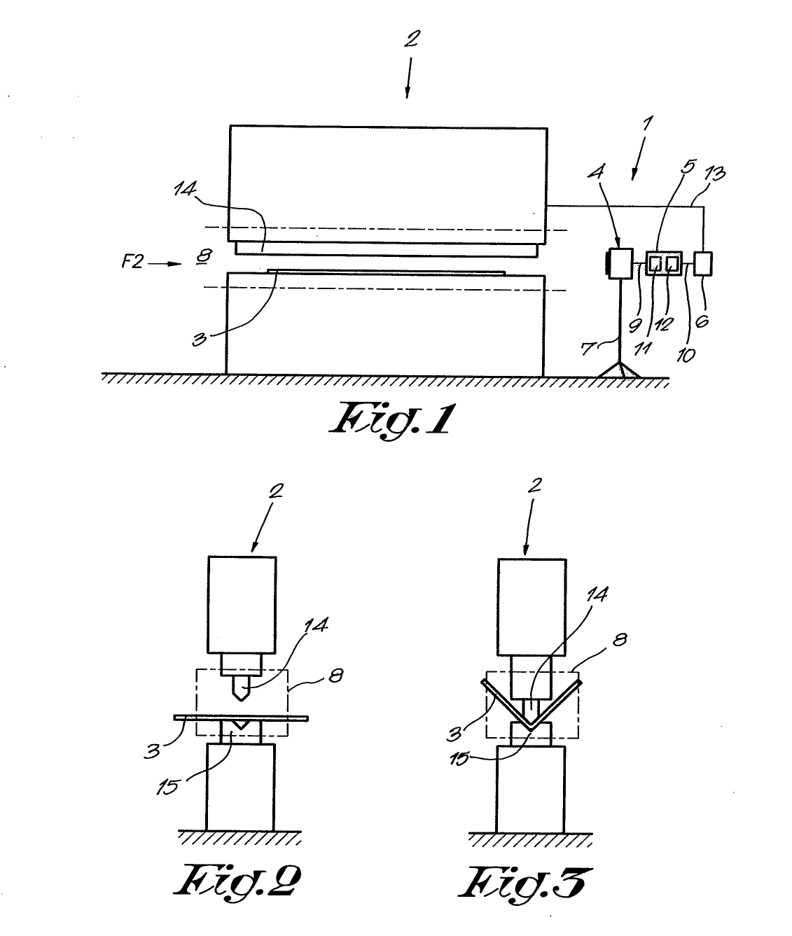

FIG. 1 represents a device which is equipped with means to apply a method according to the invention;

FIG. 2 represents a view according to arrow F2 in FIG. 1;

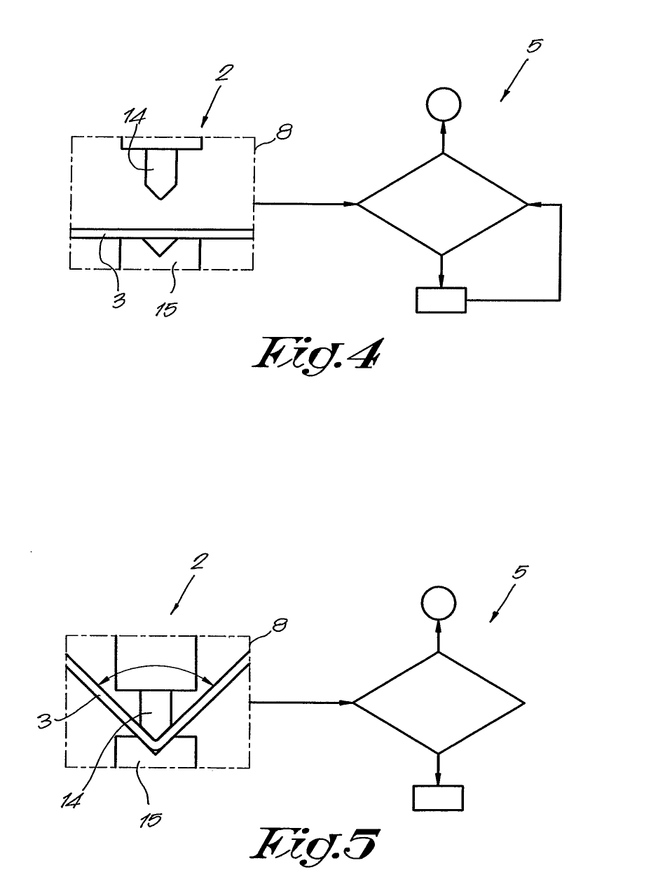

FIG. 3 represents the same view as in FIG. 2, but for another point in time during the processing of a product;

FIGS. 4 and 5 schematically represent a method according to the invention.

FIG. 1 in this case represents a device 1 for performing a quality control, set up to check the operation of, for example, a machine 2 for folding steel plates 3 or the like and/or to check the quality of the processed products, in particular the angle α at which the steel plate 3 concerned is folded and the position of the fold in relation to this steel plate 3.

The device 1 comprises an image sensor 4, for example in the form of a camera; an image processor 5; and a control unit 6.

The image sensor 4, which is in this case fixed to a stand 1, is directed towards a zone 8 of the above-mentioned machine 2 in which a steel plate 3 concerned is folded.

This image sensor 4, depending on the product to be checked, is preferably sensitive to all light frequencies between ultraviolet and infrared light, and to coherent as well as non-coherent light.

The image processor 5, which is connected to the above-mentioned image sensor 4 and the above-mentioned control unit 6 respectively by means of two cables 9-10, comprises a memory 11 and one or several processor units 12.

Finally, the control unit 6 is coupled to the machine 2 by means of a cable 13.

It is clear that the different parts of the device 1 must not necessarily be coupled by means of cables 9,10,13, but that also other means can be applied to transmit data between said parts, such as for example infrared radiation or other wireless connections.

The above-mentioned device 1 makes it possible to check the operation of a machine 2 in a very simple and efficient manner, as well as the quality of the obtained products, in this case steel plates 3.

Before the device is applied to check the operation of a machine 2 and/or to check the quality of the products 3 obtained, images of the above-mentioned zone 8 are recorded for all possible situations, for example those as represented in FIGS. 2 and 3.

These recorded images are transmitted to the above-mentioned image processor 5, where they are processed by the processor 12 and are stored in the memory 11, after which these images are used, while the device 1 is in use, as a reference to check the operation of the machine 2 or while a quality control of the processed steel plates 3 is being performed.

It is clear that the reference images can also be obtained in other ways, for example by storing the figures and/or photos in the memory 11.

In order to perform a check on the machine 2 or on the obtained steel plates 3, the images which are recorded by the image sensor 4 are directly transmitted to the image processor 5, where they are compared to the reference images in the processor 12 which are stored in the memory 11.

In case the recorded images differ from the reference images, the processor 12, as is schematically represented in FIGS. 4 and 5, will generate an error message which is transmitted to the control unit 6, which can then take a pre-programmed action.

Thus, when the steel plate 3 is for example badly placed in the machine 2, the position will be adjusted until the recorded images of the position of said steel plate 3 correspond to the pre-recorded reference images of the initial position for folding the plates 3 represented in FIG. 3, after which the folding of the steel plate 3 may start.

In another example, the action taken consists in shutting down the machine 2 and activating an alarm system so as to warn a qualified person that his/her intervention is required to correctly start up the machine 2 again.

It is also possible, of course, if the recorded images differ from the reference images, for example if the angle α at which a steel plate 3 is folded is too acute, that the product 3 will be simply rejected and will be separated from the correctly processed products 3.

If the zone 8 which is recorded by the image sensor 4 also comprises a part of the machine, the device 1 can be applied to check whether essential parts of the machine 2, in this case a stamp 14 and a mould 15 for folding steel plates 3, are not damaged; whether the stamp 14 is not blunt; whether there are no undesired objects in the mould 15. Thus, it becomes possible, should the stamp 14 and/or the mould 15 be damaged, to shut down the machine 2 in order to prevent a faulty production.

Naturally, the device 1 can also be used to check whether the stamp 14 and/or mould 15 provided in the machine 2 correspond to the desired processing that is to be carried out by the machine 2 whereby, when a faulty stamp 14 or mould 15 is detected, the production can be stopped prematurely and whereby an error signal can be generated.

It is clear that the above-described device according to the invention can be provided with one or several light sources which can be aimed either or not directly at the zone 8 which is recorded by the image sensor 4.

It is also clear that, depending on the zone 8 which is to be recorded to perform a desired quality control, several image sensors 4 can be applied, which image sensors 4 can be coupled to separate image processors 5 in this case, which are in turn connected to the above-mentioned control unit 6.

It should be noted that said one or several image sensors 4 must not necessarily be provided on a stand 7 or the like, but that they can also be hung up directly on either or not moving parts of the machine 2.

The present invention is by no means limited to the above-described embodiments represented in the accompanying drawings; on the contrary, such a method according to the invention and a device applied thereby for performing a quality control of a processed product can be realised according to many different variants while still remaining within the scope of the invention.

1. Method for performing a quality control of a processed product, comprising the steps: storing images of a first product in a memory either or both during and after its desired and correct processing; recording images of at least one similar second product to be checked either or both during and after its processing; comparing the recorded images of the second product to the images in the memory; and taking action if the recorded images differ from the images in the memory, either by rejecting the second product or repositioning or adjusting the second product.

2. Method according to claim 1, including using at least one image sensor used to record at least some of the images.

3. Method according to claim 1, wherein the action taken comprises activating an alarm system.

4. Method according to claim 1, wherein the images of the second product are recorded while the second product to be processed or the processed product is located in a machine for processing it.

5. Method according to claim 4, including first storing images in the memory of at least a part of the machine which is used to effectively process the second product either or both during and following a desired and correct action by the machine; recording images of the part either or both during and after the processing of the second product; comparing the recorded images of the part to the images of the part in the memory; and taking action when the recorded images of the part differ from the images of the part in the memory said action resulting in stopping any further operation of the machine.

6. Method according to claim 1, wherein the processing of the product comprises bending a steel plate.

7. Device for performing a quality control according to the method of claim 1, comprising at least one image sensor; at least one image processor, each image processor comprising a memory and a processor; and a control unit.

8. Device according to claim 7, wherein at least one of the image sensors is a camera.

9. Device according to claim 7, including at least one light source.

10. Device according to claim 9, wherein the light source is aimed directly at a zone which is viewed by one or several image sensors.

11. Device according to claim 9, wherein the light source is aimed indirectly at a zone which is recorded by said at least one image sensor.

12. Device according to claim 7, wherein said at least one image sensor is sensitive to all light frequencies from infrared to ultraviolet.

13. Device according to claim 7, wherein said at least one image sensor is sensitive to coherent light.

14. Device according to claim 7, wherein said at least one image sensor is sensitive to non-coherent light.
